(19) United States
(12) Patent Application Publication
(10) Pub. No.: US 2008/0165490 A1
(43) Pub. Date: Jul. 10, 2008

(54) TECHNIQUE TO SUPPORT MULTIPLE FORMS OF SAS DASD

(76) Inventors: Patrick A. Buckland, Austin, TX (US); Ray C. Laning, Kasson, MN (US); Thoi Nguyen, Austin, TX (US); Kenneth R. Peters, Rochester, MN (US); Edward J. Seminaro, Milton, NY (US); Rebeccah J. Vossberg, Rochester, MN (US)

Correspondence Address: IBM CORP. (WIP);c/o WALDER INTELLECTUAL PROPERTY LAW, P.C., P.O. BOX 832745, RICHARDSON, TX, 75083, US

(21) Appl. No.: 11/621,178

(22) Filed: Jan. 9, 2007

(51) Int. Cl. G06F 1/16

(52) U.S. Cl. 361/685

(57) ABSTRACT

A computer chassis is provided that may accommodate direct access storage device cages for various form factors. A 3.5-inch direct access storage device (DASD) cage may support 3.5-inch serial attached SCSI (SAS) direct access storage devices. The 3.5-inch SAS DASD cage includes a DASD backplane with a main connector and eight SAS drive connectors. A SFF direct access storage device cage may support SFF SAS direct access storage devices. The SFF SAS DASD cage may include a DASD backplane with a main connector and two port expanders. The port expanders may support up to twelve SAS DASD with redundant SAS channel wiring and one external 4-channel SAS port.

### BACKGROUND

1. Technical Field

The present application relates generally to direct access storage devices. More specifically, the present application is directed to a technique to support multiple forms of serial direct access storage devices.

2. Description of Related Art

A direct access storage device (DASD) is a peripheral device that is directly accessible, such as a hard disk drive. A data processing system communicates with a direct access storage device through an interface, such as an integrated drive electronics (IDE) interface or a small computer system interface (SCSI). SCSI is a hardware interface that allows for the connection of up to fifteen peripheral devices to a single peripheral component interface (PCI) board called a SCSI host adapter that plugs into the motherboard. SCSI uses a bus structure and functions like a miniature local area network. SCSI allows any two devices to communicate at one time (host to peripheral, peripheral to peripheral).

Serial attached SCSI (SAS) is a serial version of the SCSI interface, which has been parallel since its inception. SAS is a point-to-point architecture that uses a disk controller (host bus adapter) with four or more channels that operate simultaneously. SAS channels (ports) can each connect to a single drive or can connect collectively to an expander switch. Expanders can connect up to 128 devices, which may include host bus adapters and/or drives. One fanout expander can be used to connect edge expanders. Using expanders, one system may be capable of supporting a total of 16,256 drives.

A widely-used and very common direct access storage device is the hard disk drive. A hard disk drive (HDD) is a digitally encoded non-volatile storage device that stores data on rapidly rotating disks with magnetic surfaces. The disks themselves are also called “platters.” The term “drive” often refers to the entire unit containing the hard disk, read/write head assembly, driver electronics, and motor.

The size of the platters in a hard disk drive is the primary determinant of hits overall physical dimensions, also referred to as the drive's “form factor.” At one time, 5.25-inch hard disks, with a capacity of 5 megabytes, were most common. Today, by far the most common hard disk platter size in the personal computer world is 3.5 inches. Actually, the platters of 5.25-inch drives is 5.12 inches in diameter, and the platters of 3.5-inch drives is 3.74 inches in diameter. The approximate, round numbers are used out of habit. Laptop drives are usually smaller, due to the quest of manufacturers to make lighter and smaller devices. The platters of laptop drives are usually 2.5 inches in diameter or less. 2.5 inches is sometimes referred to as “small form factor” (SFF). Of course, other sizes exist, such as 1.8-inch drives.

The entire drive, which includes the platter(s), read/write head assembly, driver electronics, and motor, enclosed in a drive case, is larger than the platter size. For example, a 3.5-inch drive is usually about 4 inches wide, 5.75 inches long, and 1 inch high. A 2.5-inch drive is usually about 2.76 inches wide, 4 inches long, and less than an inch high.

Currently, the storage capacity of a typical 3.5-inch drive could range from 35 gigabytes to 300 gigabytes. The speed of rotation of a 3.5-inch drive may be between 10,000 revolutions per minute (RPM) to 15,000 RPM. The storage capacity of a typical SFF drive could be up to 72 gigabytes. The speed of a SFF drive may be about 10,000 RPM. However, improvements in storage capacity and speed, as well as smaller form factor, are being made all the time. Therefore, these numbers could grow for all form factors, although a disk drive with a larger platter will naturally have a higher storage capacity than a disk drive with a smaller platter, all other parameters being equal.

Traditionally, servers have been designed to use a plurality of 3.5-inch drives. The space in the server chassis in which the drives are placed is referred to as the “drive bays.” Typically, the server chassis is designed for a particular form factor drive. If a customer wants to use small form factor drives, the customer could mount the SFF drives in place of the 3.5-inch drives with drive mounting kits, but a SFF drive would provide less storage capacity for typically more money. Alternatively, the chassis could be built to accommodate a plurality of SFF drives. However, in this case, the customer must make a decision ahead of time. The customer is not allowed the flexibility of changing the form factor of the drives without having to change the entire server chassis.

### SUMMARY

The illustrative embodiments recognize the disadvantages of the prior art and provide a computer chassis that may accommodate direct access storage device cages for various form factors. In one embodiment, a 3.5-inch direct access storage device (DASD) cage may support up to six 3.5-inch serial attached SCSI (SAS) direct access storage devices, one digital video disk (DVD) drive, and one SAS tape drive. The 3.5-inch SAS DASD cage includes a DASD backplane with a main connector and eight SAS drive connectors.

In another embodiment, a SFF direct access storage device cage may support up to twelve SFF SAS direct access storage devices, one DVD drive, and one SAS tape drive. The SFF SAS DASD cage may include a DASD backplane with a main connector and two port expanders. The port expanders may support up to twelve SAS DASD with redundant SAS channel wiring, one DVD drive, and one SAS tape drive, and one external 4-channel SAS port. The SFF SAS DASD cage may also include an interposer that is placed between the backplane and the storage controller, due to the different dimensions of the SFF storage devices. An internal SAS cable may connect to the SFF DASD cage and provide an external SAS connection in the rear portion of the computer chassis.

In one illustrative embodiment, a method for supporting multiple form factors of serial attached small computer system interface direct access storage devices comprises providing a main computer chassis having a direct access storage device portion configured to support a direct access storage device cage of a first type or a direct access storage device cage of a second type and providing a direct access storage device cage of the first type or the second type having a serial attached small computer system interface backplane. A direct access storage device cage of a first type supports a first number of standard form factor direct access storage devices and wherein the serial attached small computer system interface backplane comprises the first number of direct access storage device connectors. A direct access storage device cage of a second type supports a second number of small form factor direct access storage devices and wherein the serial attached small computer system interface backplane comprises the second number of direct access storage device connectors.

In one exemplary embodiment, the standard form factor direct access storage devices are 3.5-inch hard disk drives. In another exemplary embodiment, the small form factor direct access storage devices are 2.5-inch hard disk drives. In a further exemplary embodiment, the serial attached small computer system interface backplane comprises at least one port expander.

In another exemplary embodiment, the main computer chassis has a serial attached small computer system interface controller and wherein the serial attached small computer system interface backplane comprises a main connector. The method further comprises connecting the main connector to the serial attached small computer system interface controller. In a further exemplary embodiment, the direct access storage device cage is of the second type and connecting the main connector to the serial attached small computer system interface controller comprises connecting the main connector to an interposer and connecting the interposer to the serial attached small computer system interface controller.

In yet another exemplary embodiment, the serial attached small computer system interface backplane comprises a guiding connector that does not provide any electrical connection.

In a still further exemplary embodiment, the main computer chassis has an external serial attached small computer system interface connector. The serial attached small computer system interface backplane comprises a secondary connector. The method further comprises connecting a first end of a serial attached small computer system interface cable to the secondary connector and connecting a second end of the serial attached small computer system interface cable to the external serial attached small computer system interface connector.

In another exemplary embodiment, the direct access storage device cage is of the first type, and the method further comprises connecting standard form factor direct access storage devices to at least a subset of the first number of direct access storage device connectors. In yet another exemplary embodiment, the direct access storage device cage is of the second type, and the method further comprises connecting small form factor direct access storage devices to at least a subset of the second number of direct access storage device connectors.

In another illustrative embodiment, a computer system is provided that supports multiple form factors of serial attached small computer system interface direct access storage devices. The computer system comprises a main computer chassis having a direct access storage device portion configured to support a direct access storage device cage of a first type or a direct access storage device cage of a second type and a direct access storage device cage of the first type or the second type having a serial attached small computer system interface backplane. A direct access storage device cage of a first type supports a first number of standard form factor direct access storage devices. The serial attached small computer system interface backplane comprises the first number of direct access storage device connectors. A direct access storage device cage of a second type supports a second number of small form factor direct access storage devices. The serial attached small computer system interface backplane comprises the second number of direct access storage device connectors.

In one exemplary embodiment, the standard form factor direct access storage devices are 3.5-inch hard disk drives. In another exemplary embodiment, the small form factor direct access storage devices are 2.5-inch hard disk drives. In a further exemplary embodiment, the serial attached small computer system interface backplane comprises at least one port expander.

In another exemplary embodiment, the main computer chassis has a serial attached small computer system interface controller. The serial attached small computer system interface backplane comprises a main connector. The main connector connects to the serial attached small computer system interface controller. In a further exemplary embodiment, the direct access storage device cage is of the second type, and the main connector is connected to the serial attached small computer system interface controller using an interposer.

In yet another exemplary embodiment, the serial attached small computer system interface backplane comprises a guiding connector that does not provide any electrical connection. In a further exemplary embodiment, the main computer chassis has an external serial attached small computer system interface connector. The serial attached small computer system interface backplane comprises a secondary connector. The computer system further comprises a serial attached small computer system interface cable. A first end of the serial attached small computer system interface cable is connected to the secondary connector and a second end of the serial attached small computer system interface cable is connected to the external serial attached small computer system interface connector.

In a still further exemplary embodiment, the direct access storage device cage is of the first type. The computer system further comprises one or more standard form factor direct access storage devices connected to at least a subset of the first number of direct access storage device connectors. In another exemplary embodiment, the direct access storage device cage is of the second type. The computer system further comprises one or more small form factor direct access storage devices connected to at least a subset of the second number of direct access storage device connectors.

These and other features and advantages of the present invention will be described in, or will become apparent to those of ordinary skill in the art in view of, the following detailed description of the exemplary embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a block diagram of a serially attached SCSI controller card with which aspects of the illustrative embodiments may be implemented;

FIGS. 2A and 2B are block diagrams illustrating exemplary standard form factor direct access storage device backplanes in accordance with illustrative embodiments;

FIG. 3 is a block diagram illustrating an exemplary small form factor direct access storage device backplane in accordance with an illustrative embodiment;

FIG. 4 is a pictorial representation of a computer chassis in accordance with an illustrative embodiment;

FIG. 5 is a pictorial representation of a computer chassis with a standard form factor direct access storage device cage in accordance with an exemplary embodiment;

FIGS. 6A-6C are pictorial representations of standard form factor direct access storage device cages in accordance with illustrative embodiments;

FIG. 6D is a pictorial representation of a lower cost standard form factor DASD backplane in accordance with an illustrative embodiment;

FIG. 6E is a front isometric view of the lower cost standard form factor direct access storage device backplane in accordance with an illustrative embodiment;

FIG. 6F is a pictorial representation of a higher function standard form factor DASD backplane in accordance with an illustrative embodiment;

FIG. 6G is a front isometric view of the higher function standard form factor direct access storage device backplane in accordance with an illustrative embodiment;

FIGS. 7A and 7B illustrate exemplary embodiments. Modifications to the small form factor DASD cage may be made within the spirit and scope of the present invention;

FIG. 7C is a pictorial representation of a small form factor DASD backplane in accordance with an illustrative embodiment;

FIG. 7D is a front isometric view of the small form factor direct access storage device backplane in accordance with an illustrative embodiment;

FIG. 7E is a pictorial representation of an interposer in accordance with an illustrative embodiment;

FIGS. 8A-8E are pictorial representations of an internal serial attached SCSI cable in accordance with illustrative embodiments;

FIG. 9 is a flowchart illustrating configuration of a computer chassis with a standard form factor direct access storage device cage in accordance with an illustrative embodiment; and

FIG. 10 is a flowchart illustrating configuration of a computer chassis with a small form factor direct access storage device cage in accordance with an illustrative embodiment.

### DETAILED DESCRIPTION OF THE ILLUSTRATIVE EMBODIMENTS

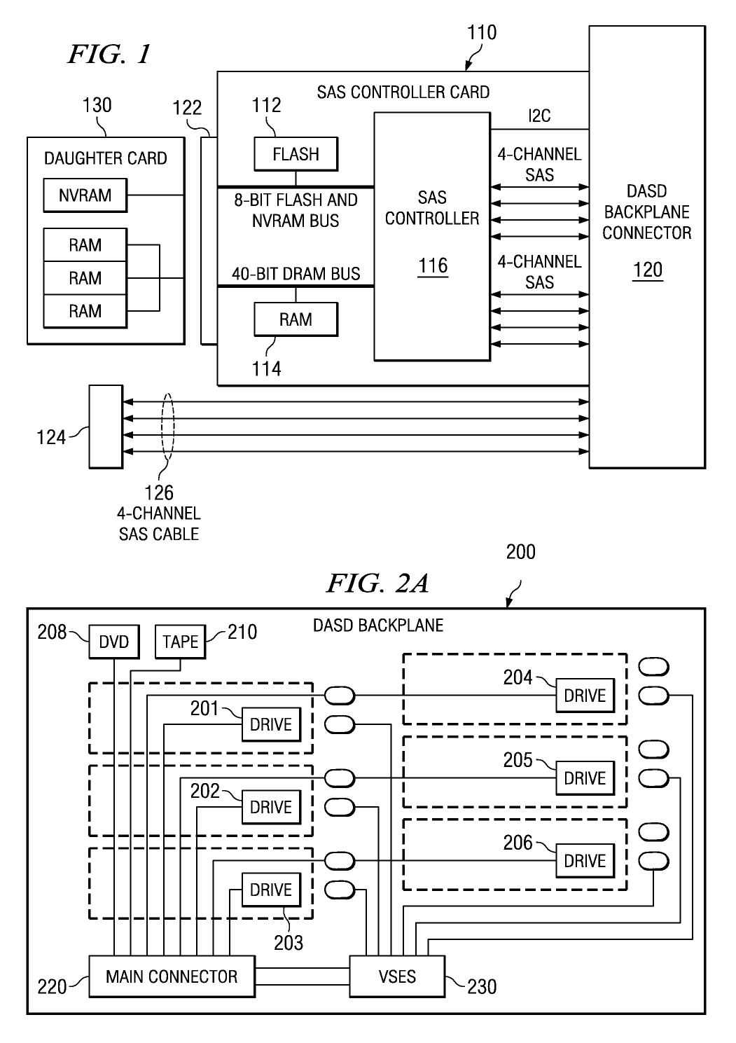

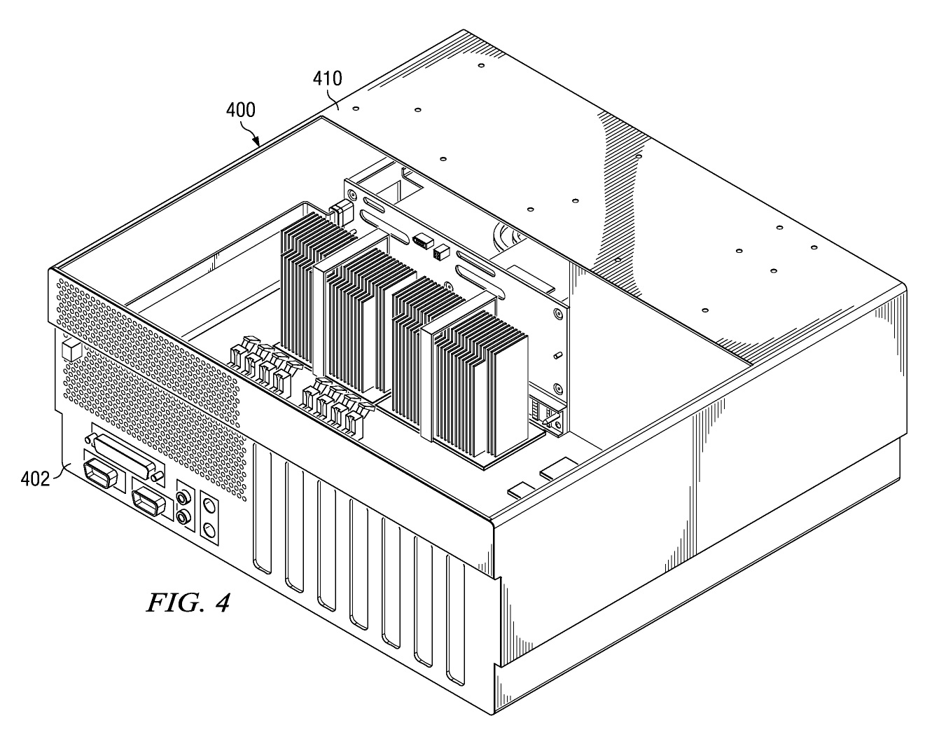

With reference now to the figures and in particular with reference to FIGS. 1 and 4, exemplary diagrams of computer environments are provided in which illustrative embodiments of the present invention may be implemented. It should be appreciated that FIGS. 1 and 4 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a block diagram of a serially attached SCSI controller card with which aspects of the illustrative embodiments may be implemented. Serial attached SCSI (SAS) controller card 110, also referred to as a “host adapter,” includes direct access storage device (DASD) backplane connector 120. SAS controller 116 provides two 4-channel SAS connections and an inter-integrated circuit (IIC or I2C) connection to DASD backplane connector 120.

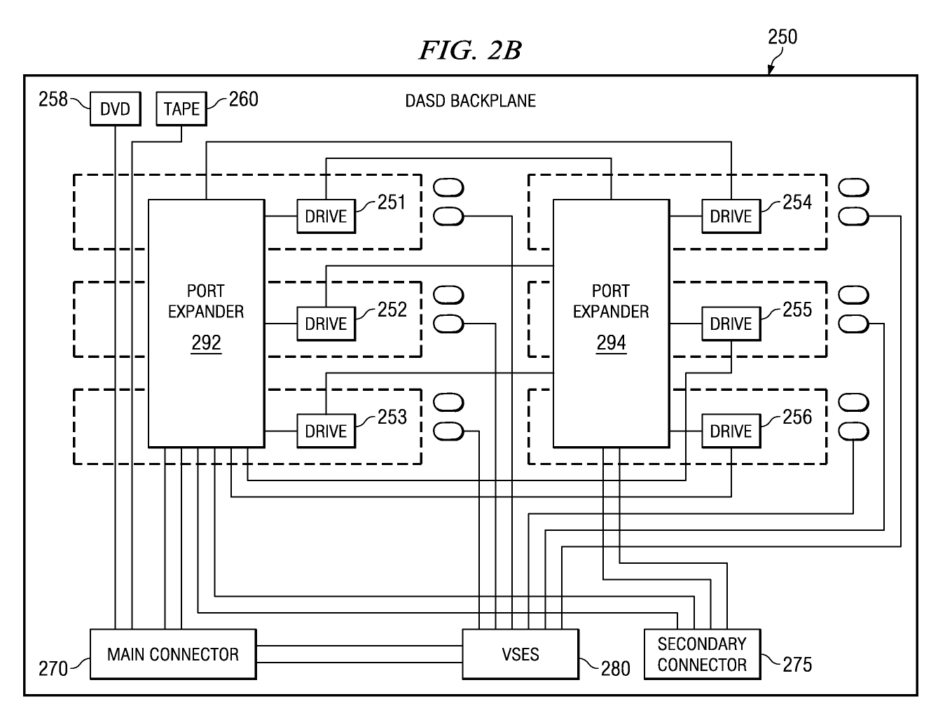

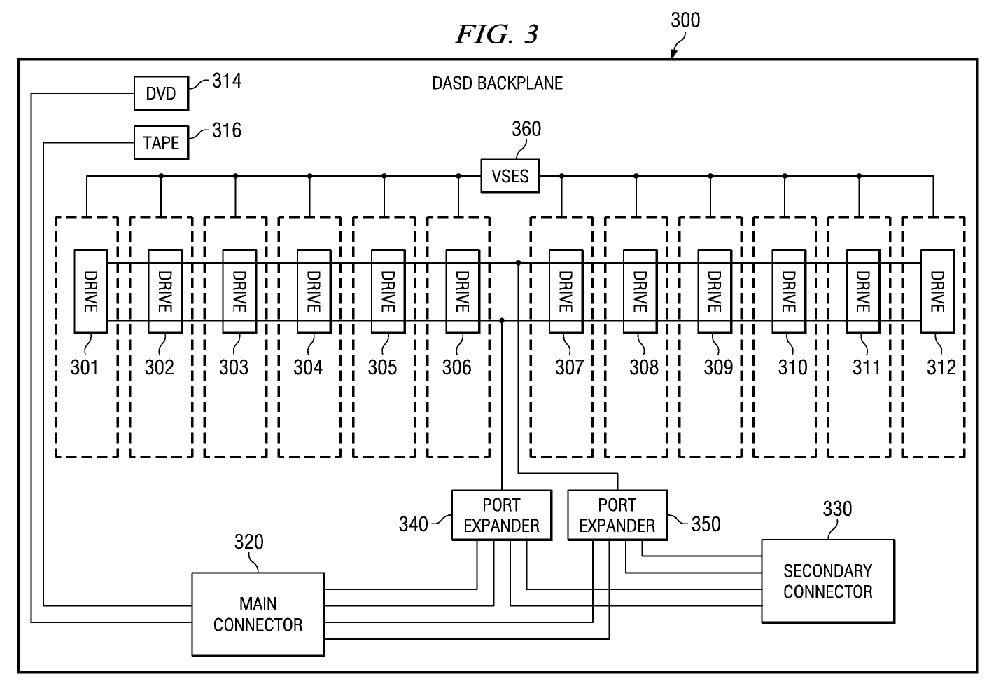

Daughter card 130 may connect to SAS controller card 110 through connector 122. Daughter card 130 includes additional non-volatile random access memory (NVRAM) and random access memory (RAM). SAS controller 116 connects to connector 122 and, thus, daughter card 130 through an 8-bit Flash and NVRAM bus and a 40-bit dynamic RAM (DRAM) bus. Furthermore, 4-channel SAS cable 126 may connect DASD backplane connector 120 to external SAS connector 124. Connector 120 may include a main connector, for connection to, for example, connector 220 in FIG. 2A, connector 270 in FIG. 2B, or connector 320 in FIG. 3. In addition, DASD backplane connector 120 may include a secondary connector for connecting to 4-channel SAS cable 126.

FIGS. 2A and 2B are block diagrams illustrating exemplary standard form factor direct access storage device backplanes in accordance with illustrative embodiments. More particularly, FIG. 2A illustrates a lower cost standard form factor backplane in accordance with one illustrative embodiment. Direct access storage device (DASD) backplane 200 includes main connector 220, which connects to a serial attached SCSI (SAS) controller card, such as SAS controller card 110 in FIG. 1.

In the depicted example, main connector 220 also connects to six drive connectors 201-206. Virtual SCSI enclosure services (VSES) 230 connects to drive connectors 201-206. VSES 230 provides hot-pluggable and hot-swappable control for drive connectors 201-206.

An operator may connect up to six standard form factor direct access storage devices, such as 3.5-inch hard disk drives, to connectors 201-206. Main connector 220 also connects to digital video disk (DVD) connector 208 and SAS tape drive connector 210. An operator may also connect a DVD drive, such as a serial advanced technology attachment (SATA) DVD drive, and/or a SAS tape drive using connectors 208, 210.

FIG. 2B illustrates a higher function standard form factor backplane in accordance with one illustrative embodiment. Direct access storage device (DASD) backplane 250 includes main connector 270, which connects to a serial attached SCSI (SAS) controller card, such as SAS controller card 110 in FIG. 1.

In the depicted example, main connector 270 connects to port expanders 292, 294, which connect to up to six drive connectors 251-256. An operator may connect up to six standard form factor direct access storage devices, such as 3.5-inch hard disk drives, to connectors 251-256. Main connector 270 also connects to digital video disk (DVD) connector 258 and SAS tape drive connector 260. An operator may also connect a DVD drive, such as a serial advanced technology attachment (SATA) DVD drive, and/or a SAS tape drive using connectors 258, 260.

In addition, DASD backplane 250 includes secondary connector 275, which connects to port expanders 292, 294. Secondary connector 275 provides a connector for an internal SAS cable, which may provide an external SAS connector at a rear portion of the computer chassis, to be described in further detail below. Virtual SCSI enclosure services (VSES) 280 connects to drive connectors 251-256. VSES 280 provides hot-pluggable and hot-swappable control for drive connectors 251-256.

FIG. 3 is a block diagram illustrating an exemplary small form factor direct access storage device backplane in accordance with an illustrative embodiment. Direct access storage device (DASD) backplane 300 includes main connector 320, which connects to a serial attached SCSI (SAS) controller card, such as SAS controller card 110 in FIG. 1.

In the depicted example, main connector 320 connects to port expanders 340, 350, which connect to up to twelve drive connectors 301-312. An operator may connect up to twelve small form factor direct access storage devices, such as 2.5-inch hard disk drives, to connectors 301-312. Main connector 320 also connects to digital video disk (DVD) connector 314 and SAS tape drive connector 316. An operator may also connect a DVD drive, such as a serial advanced technology attachment (SATA) DVD drive, and/or a SAS tape drive using connectors 314, 316.

In addition, DASD backplane 300 includes secondary connector 330, which connects to port expanders 340, 350. Secondary connector 320 provides a connector for an internal SAS cable, which may provide an external SAS connector at a rear portion of the computer chassis, to be described in further detail below. Virtual SCSI enclosure services (VSES) 360 connects to drive connectors 301-312. VSES 360 provides hot-pluggable and hot-swappable control for drive connectors 301-312.

FIG. 4 is a pictorial representation of a computer chassis in accordance with an illustrative embodiment. Computer chassis 400 includes a front portion 410 in which a serial attached SCSI (SAS) direct access storage device (DASD) cage may be located or installed. In accordance with the illustrative embodiments, a standard form factor DASD cage may support up to a first number of standard form factor direct access storage devices, while a small form factor DASD cage may support a second number of small form factor direct access storage devices, where the second number is greater than the first number.

In one exemplary embodiment, a standard form factor may support up to six 3.5-inch DASD. In another exemplary embodiment, a small form factor may support up to twelve 2.5-inch DASD. However, in other exemplary embodiments, 2.5-inch drives may be considered standard form factor, while 1.8-inch drives may be considered small form factor. The number of drives supported in each form factor DASD cage may vary based on the size of the computer chassis, the size of the cage, the storage capacity needed in the computer device, the capabilities of the backplanes, etc.

In one exemplary embodiment, rear portion 402 of chassis 400 may provide an external SAS connector if the SAS DASD cage is a small form factor DASD cage, as will be described below.

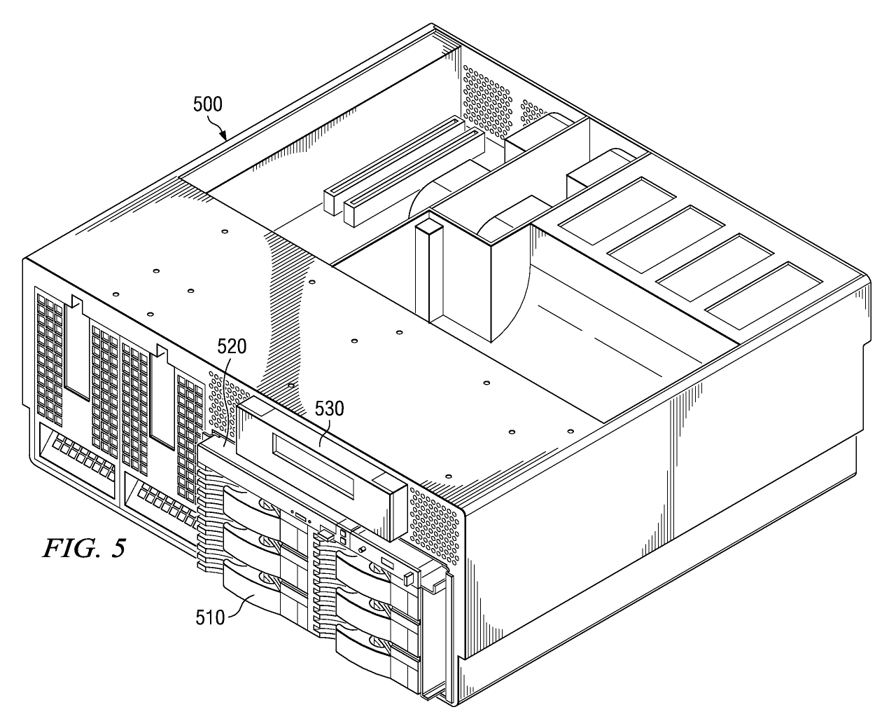

FIG. 5 is a pictorial representation of a computer chassis with a standard form factor direct access storage device cage in accordance with an exemplary embodiment. Computer chassis 500 has a standard form factor DASD cage installed therein. In the depicted example, the DASD cage has installed therein six standard form factor DASD 510, DVD drive 520, and tape drive 530.

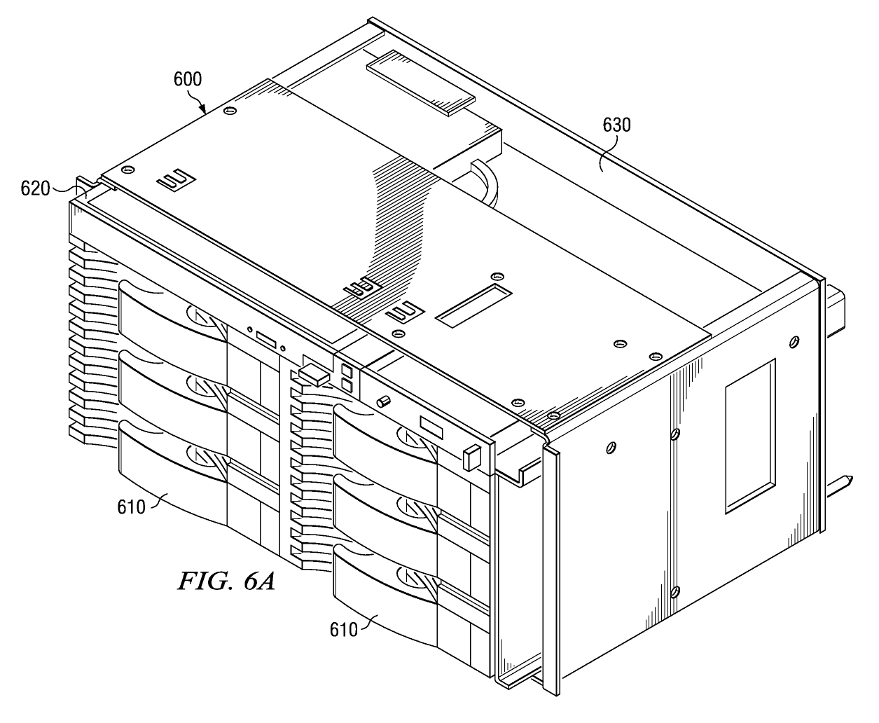

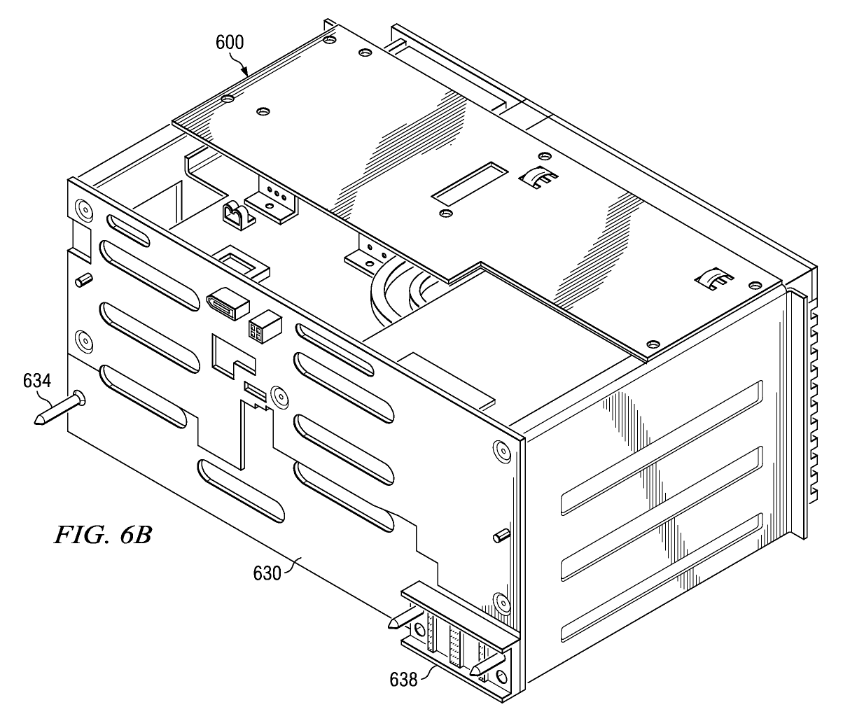

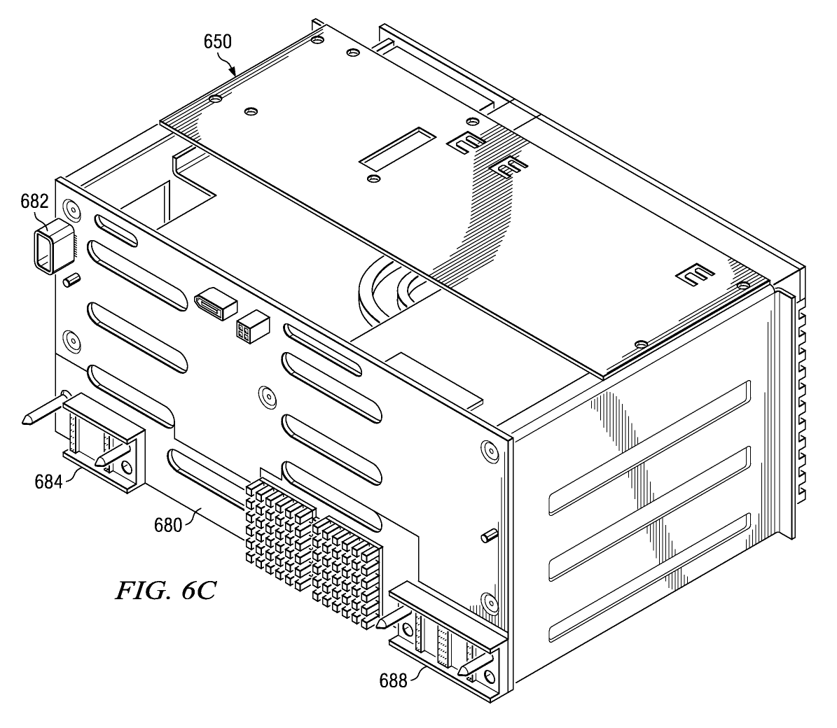

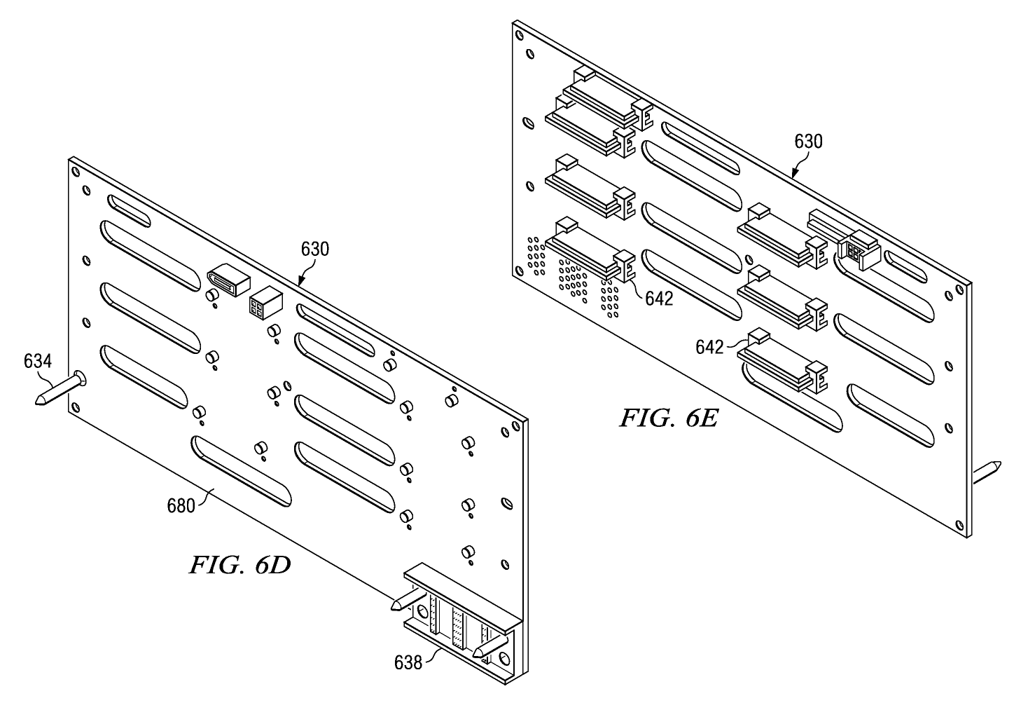

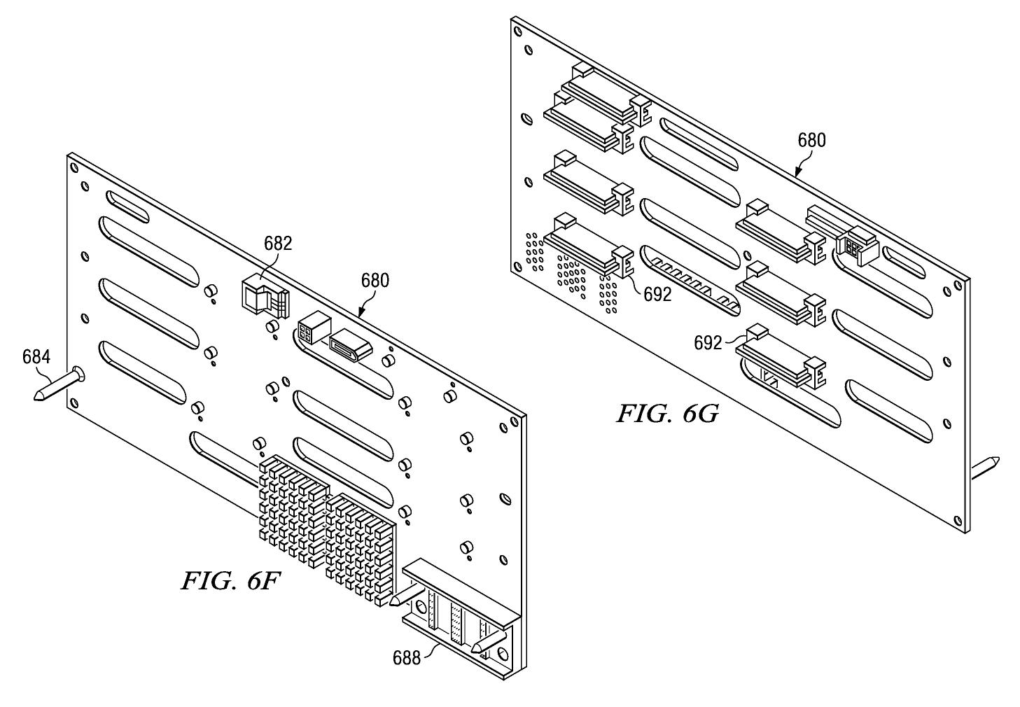

FIGS. 6A-6C are pictorial representations of standard form factor direct access storage device cages in accordance with illustrative embodiments. More particularly, FIG. 6A is a front isometric view of a standard form factor DASD cage in accordance with the illustrative embodiment. In the depicted example, DASD cage 600 has six standard form factor direct access storage devices 610 installed therein. DASD cage 600 may also support DVD drive 620. In an alternative embodiment, although not shown, DASD cage 600 may further support a SAS tape drive. However, the tape drive, while supported by the backplane 630, may also be located outside of DASD cage 600.

FIG. 6B is a rear isometric view of a standard form factor DASD cage with a lower cost DASD backplane in accordance with an illustrative embodiment. DASD cage 600 includes lower cost DASD backplane 630, which may be, for example, DASD backplane 200 of FIG. 2A. DASD backplane 630 does not provide a connector for an internal serial attached SCSI (SAS) cable. DASD backplane 630 includes SAS controller connector 638, which connects the backplane to a SAS controller card. Thus, connector 638 may be, for example, main connector 220 in FIG. 2A. Connector 634 is a guiding mechanism that helps hold DASD backplane in place, but does not provide any electrical connection.

FIG. 6C is a rear isometric view of a standard form factor DASD cage with a lower cost DASD backplane in accordance with an illustrative embodiment. DASD cage 650 includes lower cost DASD backplane 680, which may be, for example, DASD backplane 250 of FIG. 2B. DASD backplane 680 provides connector 682 for an internal serial attached SCSI (SAS) cable, which may connect to an external connector in the rear portion of the computer chassis. DASD backplane 680 also includes SAS controller connector 688, which connects the backplane to a SAS controller card. Thus, connector 688 may be, for example, main connector 270 in FIG. 2B. Connector 684 is a guiding mechanism that helps hold DASD backplane in place, but does not provide any electrical connection.

FIGS. 6A-6C illustrate exemplary embodiments. Modifications to the standard form factor DASD cage may be made within the spirit and scope of the present invention. For example, the number of drives supported by a standard form factor DASD cage may vary depending on the size of the cage, the size of the drives, and so forth. Furthermore, one or more interposers may be used to connect the standard form factor DASD backplane 630 or 680 to other components within the computer chassis.

FIG. 6D is a pictorial representation of a lower cost standard form factor DASD backplane in accordance with an illustrative embodiment. DASD backplane 630 provides SAS controller connector 638, which connects the backplane to a SAS controller card. Thus, connector 638 may be, for example, main connector 220 in FIG. 2A. Connector 634 is a guiding mechanism that helps hold DASD backplane in place, but does not provide any electrical connection.

FIG. 6E is a front isometric view of the lower cost standard form factor direct access storage device backplane in accordance with an illustrative embodiment. DASD backplane 630 includes six serial attached SCSI (SAS) drive connectors 642. In the depicted example, an operator may connect up to six standard form factor SAS drives, such as 3.5-inch SAS hard disk drives, to drive connectors 642. The number of standard form factor drives may vary depending upon the implementation.

FIG. 6F is a pictorial representation of a higher function standard form factor DASD backplane in accordance with an illustrative embodiment. DASD backplane 680 provides connector 682 for an internal serial attached SCSI (SAS) cable, which may connect to an external connector in the rear portion of the computer chassis. Thus, connector 682 may be, for example, secondary connector 275 in FIG. 2B.

DASD backplane 680 also includes SAS controller connector 688, which connects the backplane to a SAS controller card. Thus, connector 688 may be, for example, main connector 270 in FIG. 2B. Connector 684 is a guiding mechanism that helps hold DASD backplane in place, but does not provide any electrical connection.

FIG. 6G is a front isometric view of the higher function standard form factor direct access storage device backplane in accordance with an illustrative embodiment. DASD backplane 680 includes six serial attached SCSI (SAS) drive connectors 692. In the depicted example, an operator may connect up to six standard form factor SAS drives, such as 3.5-inch SAS hard disk drives, to drive connectors 692. The number of standard form factor drives may vary depending upon the implementation.

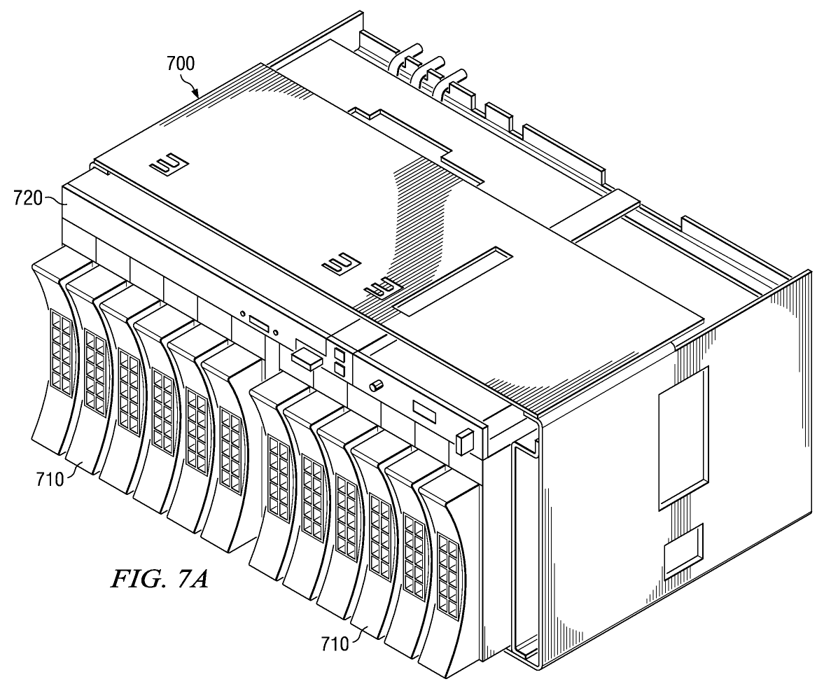

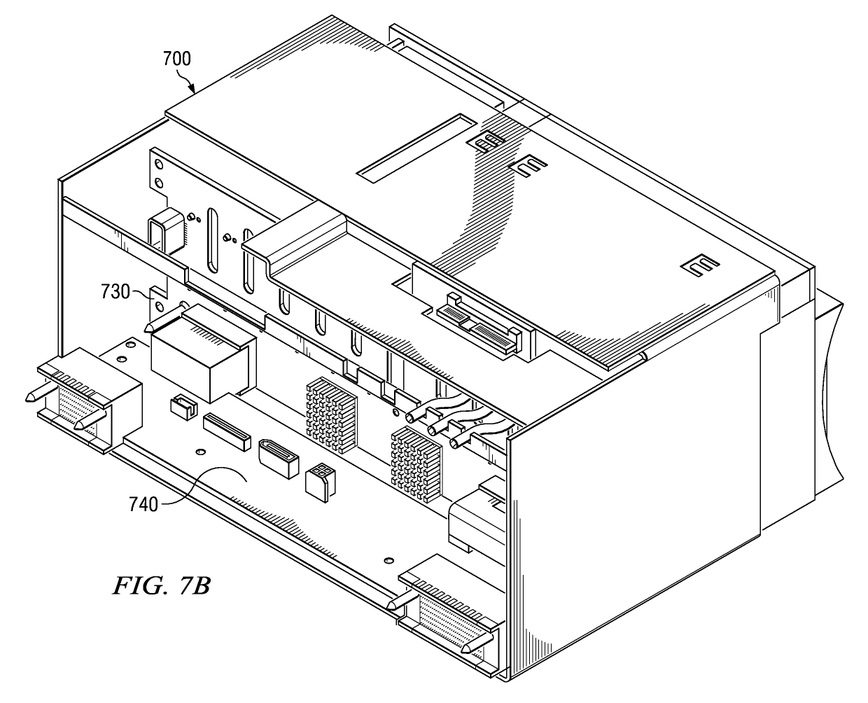

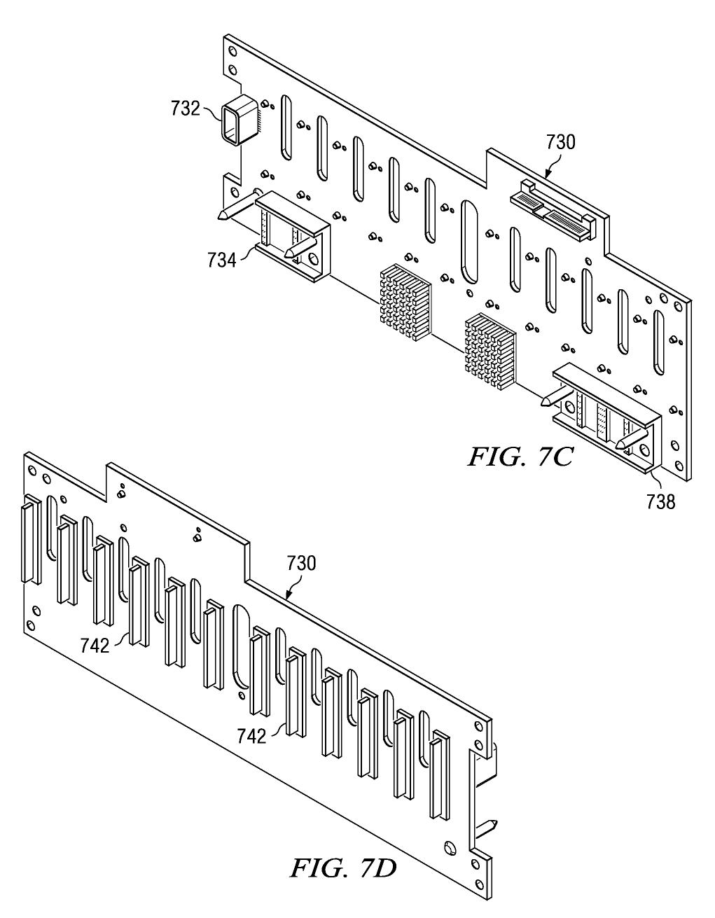

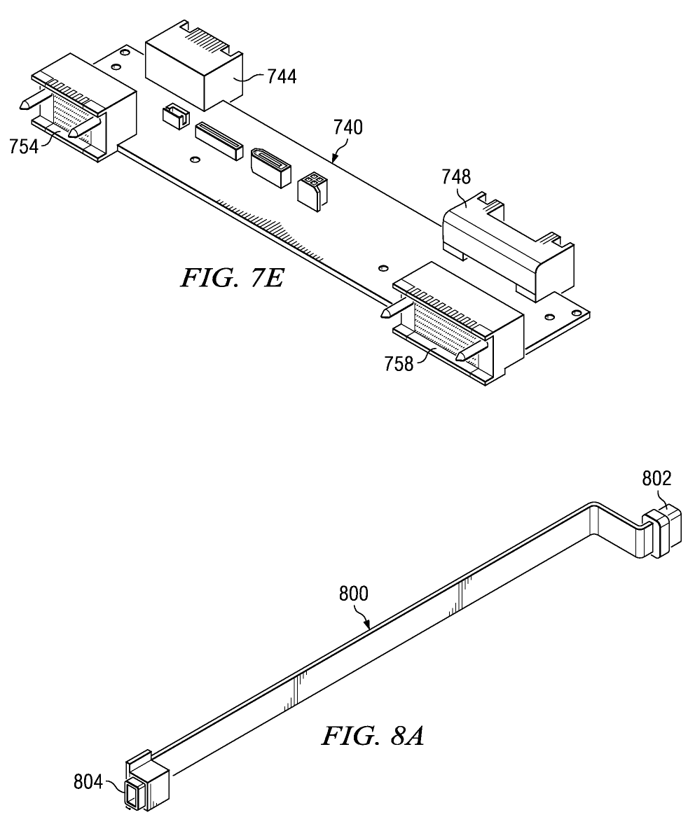

FIGS. 7A and 7B are pictorial representations of a small form factor direct access storage device cage in accordance with an illustrative embodiment. More particularly, FIG. 7A is a front isometric view of a small form factor DASD cage in accordance with the illustrative embodiment. In the depicted example, DASD cage 700 has twelve small form factor direct access storage devices 710 installed therein. DASD cage 700 may also support DVD drive 720. In an alternative embodiment, although not shown, DASD cage 700 may further support a SAS tape drive. However, the tape drive, while supported by the backplane (shown in FIG. 7B), may also be located outside of DASD cage 700.

FIG. 7B is a rear isometric view of a small form factor DASD cage in accordance with the illustrative embodiment. DASD cage 700 includes DASD backplane 730, which may be, for example, DASD backplane 300 of FIG. 3. DASD backplane 730 is connected to other components in the computer chassis using interposer 740, due to the smaller size of the drives and, thus, the position of DASD backplane 730.

FIGS. 7A and 7B illustrate exemplary embodiments. Modifications to the small form factor DASD cage may be made within the spirit and scope of the present invention. For example, the number of drives supported by a small form factor DASD cage may vary depending on the size of the cage, the size of the drives, and so forth. Furthermore, two or more interposers may be used to connect the small form factor DASD backplane 730 to other components within the computer chassis.

FIG. 7C is a pictorial representation of a small form factor DASD backplane in accordance with an illustrative embodiment. DASD backplane 730 provides connector 732 for an internal serial attached SCSI (SAS) cable, which may connect to an external connector in the rear portion of the computer chassis. Thus, connector 732 may be, for example, secondary connector 330 in FIG. 3.

DASD backplane 730 also includes SAS controller connector 738, which connects the backplane to a SAS controller card. Thus, connector 738 may be, for example, main connector 320 in FIG. 3. Connector 734 is a guiding mechanism that helps hold DASD backplane in place, but does not provide any electrical connection.

FIG. 7D is a front isometric view of the small form factor direct access storage device backplane in accordance with an illustrative embodiment. DASD backplane 730 includes twelve serial attached SCSI (SAS) drive connectors 742. In the depicted example, an operator may connect up to twelve small form factor SAS drives, such as 2.5-inch SAS hard disk drives, to drive connectors 742. However, in alternative embodiments, small form factor drives may be 1.8-inch drives, for instance. The number of small form factor drives may vary depending upon the implementation.

FIG. 7E is a pictorial representation of an interposer in accordance with an illustrative embodiment. Interposer 740 extends connectors of the small form factor DASD backplane to match the dimensions of the standard form factor DASD cage. Connector 748 is a SAS controller connector, which may connect to SAS connector 738 in FIG. 7C, for example. Connector 744 is a guiding connector, which does not have any electrical connection. Connector 744 may connect to guiding connector 734 in FIG. 7C, for example.

Connector 758 is electrically connected to connector 748 through interposer 740. Connector 758 may connect to a SAS controller, such as connector 120 in FIG. 1. Connector 754 is a guiding connector that does not have any electrical connection.

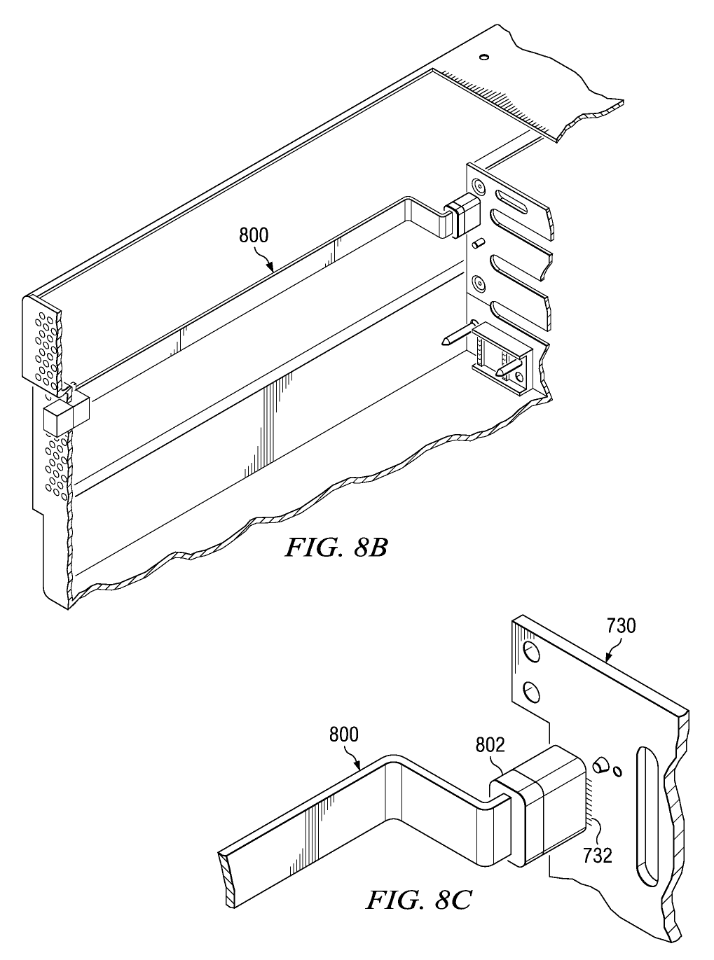

FIGS. 8A-8E are pictorial representations of an internal serial attached SCSI cable in accordance with illustrative embodiments. With reference to FIG. 8A, internal SAS cable 800 connects a DASD backplane of a DASD cage to an external connector at an external portion of the computer chassis. Internal SAS cable 800 includes connector 802, which may connect to a DASD backplane connector, such as connector 732 in FIG. 7C or connector 682 in FIG. 6F. On the other end of internal SAS cable 800, connector 804 may be coupled to the computer chassis to provide an external connector. Alternatively, connector 804 may connect to a connector or interposer in the computer chassis.

FIG. 8B depicts the internal SAS cable within the computer chassis. In the depicted example, internal SAS cable 800 connects to the DASD backplane of the DASD cage on one end and to the computer chassis on the other end. Turning to FIG. 8C, connector 802 of internal SAS cable 800 may connect to connector 732 on DASD backplane 730 or connector 682 on DASD backplane 680. With reference now to FIG. 8D, connector 804 of internal SAS cable 800 connects to rear portion 402 of the computer chassis of FIG. 4. FIG. 8E illustrates how internal SAS cable 800 may be positioned on the inside of the computer chassis, providing connector 804 to the rear of the computer chassis without interfering with other computer components, such as component 810.

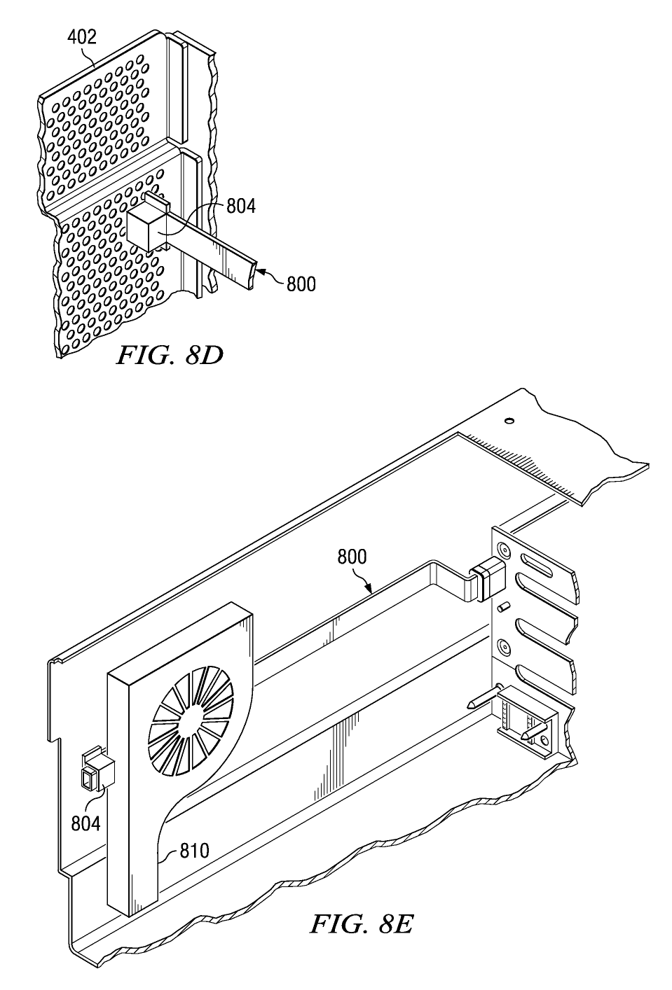

FIG. 9 is a flowchart illustrating configuration of a computer chassis with a standard form factor direct access storage device cage in accordance with an illustrative embodiment. Operation begins, and an operator inserts up to six standard form factor serial attached SCSI (SAS) drives into a standard form factor SAS direct access storage device (DASD) cage, which has a standard form factor DASD backplane, and the user attaches the drives to connectors on the backplane (block 902). The operator then inserts the standard form factor DASD cage with the standard form factor DASD backplane into the main computer chassis (block 904).

Then, the operator connects the SAS DASD backplane to a SAS controller card (block 906). The operator then connects an internal SAS cable to the SAS DASD backplane in the standard form factor DASD cage (block 908). The operator connects the internal SAS cable to an external connector on the back of the main chassis, or to the chassis itself, exposing the connector of the internal SAS cable to the outside of the main chassis (block 910). Thereafter, operation ends. Note, however, that blocks 908 and 910 may be performed for a higher function standard form factor DASD backplane, but may not be performed for a lower cost standard form factor DASD backplane that does not have a secondary connector.

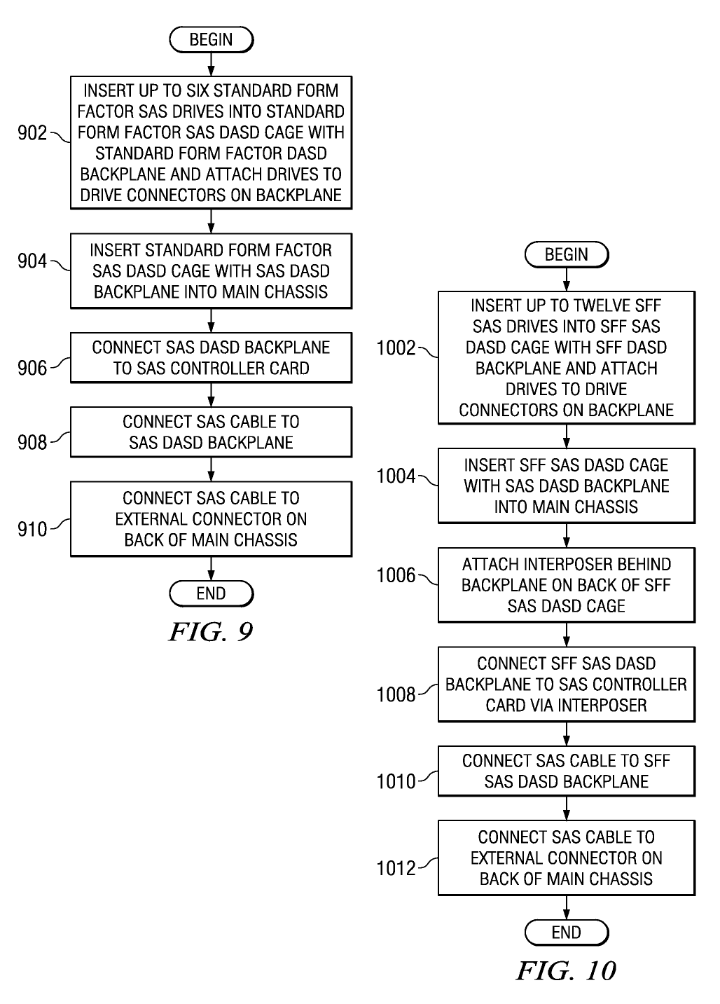

FIG. 10 is a flowchart illustrating configuration of a computer chassis with a small form factor direct access storage device cage in accordance with an illustrative embodiment. Operation begins, and an operator inserts up to twelve small form factor (SFF) serial attached SCSI (SAS) drives into a small form factor SAS direct access storage device (DASD) cage, which has a small form factor DASD backplane, and the user attaches the drives to connectors on the backplane (block 1002). The operator then inserts the small form factor DASD cage with the small form factor DASD backplane into the main computer chassis (block 1004).

Then, the operator attaches an interposer behind the backplane on the back of the small form factor SAS DASD cage (block 1006). The operator connects the SAS DASD backplane to a SAS controller card via the interposer (block 1008). The operator then connects an internal SAS cable to the SAS DASD backplane in the small form factor DASD cage (block 1010). The operator connects the internal SAS cable to an external connector on the back of the main chassis, or to the chassis itself, exposing the connector of the internal SAS cable to the outside of the main chassis (block 1012). Thereafter, operation ends.

In the exemplary embodiments illustrated in the flowcharts of FIGS. 9 and 10, a standard form factor may support up to six direct access storage devices, such as 3.5-inch hard disk drives, in addition to a DVD drive and SAS tape drive, for example. In another exemplary embodiment, a small form factor may support up to twelve direct access storage devices, such as 2.5-inch hard disk drives, in addition to a DVD drive and SAS tape drive, for example. However, in other exemplary embodiments, 2.5-inch drives may be considered standard form factor, while 1.8-inch drives may be considered small form factor. The number of drives supported in each form factor DASD cage may vary based on the size of the computer chassis, the size of the cage, the storage capacity needed in the computer device, the capabilities of the backplanes, etc.

Thus, the illustrative embodiments solve the disadvantages of the prior art by providing a computer chassis that may accommodate direct access storage device cages for various form factors. In one embodiment, a 3.5-inch direct access storage device (DASD) cage may support up to six 3.5-inch serial attached SCSI (SAS) direct access storage devices, one digital video disk (DVD) drive, and one SAS tape drive. The 3.5-inch SAS DASD cage includes a DASD backplane with a main connector and eight SAS drive connectors. An internal SAS cable may connect to the DASD cage and provide an external SAS connection in the rear portion of the computer chassis.

In another embodiment, a SFF direct access storage device cage may support up to twelve SFF SAS direct access storage devices, one DVD drive, and one SAS tape drive. The SFF SAS DASD cage may include a DASD backplane with a main connector and two port expanders. The port expanders may support up to twelve SAS DASD with redundant SAS channel wiring, one DVD drive, and one SAS tape drive, and one external 4-channel SAS port. The SFF SAS DASD cage may also include an interposer that is placed between the backplane and the storage controller, due to the different dimensions of the SFF storage devices. An internal SAS cable may connect to the SFF DASD cage and provide an external SAS connection in the rear portion of the computer chassis.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for supporting multiple form factors of serial attached small computer system interface direct access storage devices, the method comprising:
providing a main computer chassis having a direct access storage device portion configured to support a direct access storage device cage of a first type or a direct access storage device cage of a second type; and
providing a direct access storage device cage of the first type or the second type having a serial attached small computer system interface backplane,
wherein a direct access storage device cage of a first type supports a first number of standard form factor direct access storage devices and wherein the serial attached small computer system interface backplane comprises the first number of direct access storage device connectors, and
wherein a direct access storage device cage of a second type supports a second number of small form factor direct access storage devices and wherein the serial attached small computer system interface backplane comprises the second number of direct access storage device connectors.

2. The method of claim 1, wherein the standard form factor direct access storage devices are 3.5-inch hard disk drives.

3. The method of claim 1, wherein the small form factor direct access storage devices are 2.5-inch hard disk drives.

4. The method of claim 1, wherein the serial attached small computer system interface backplane comprises at least one port expander.

5. The method of claim 1, wherein the main computer chassis has a serial attached small computer system interface controller and wherein the serial attached small computer system interface backplane comprises a main connector, the method further comprising:
connecting the main connector to the serial attached small computer system interface controller.

6. The method of claim 5, wherein the direct access storage device cage is of the second type, wherein connecting the main connector to the serial attached small computer system interface controller comprises:
connecting the main connector to an interposer; and
connecting the interposer to the serial attached small computer system interface controller.

7. The method of claim 1, wherein the serial attached small computer system interface backplane comprises a guiding connector that does not provide any electrical connection.

8. The method of claim 1, wherein the main computer chassis has an external serial attached small computer system interface connector and wherein the serial attached small computer system interface backplane comprises a secondary connector, the method further comprising:
connecting a first end of a serial attached small computer system interface cable to the secondary connector; and
connecting a second end of the serial attached small computer system interface cable to the external serial attached small computer system interface connector.

9. The method of claim 1, wherein the direct access storage device cage is of the first type, the method further comprising:
connecting standard form factor direct access storage devices to at least a subset of the first number of direct access storage device connectors.

10. The method of claim 1, wherein the direct access storage device cage is of the second type, the method further comprising:
connecting small form factor direct access storage devices to at least a subset of the second number of direct access storage device connectors.

11. A computer system supporting multiple form factors of serial attached small computer system interface direct access storage devices, the computer system comprising:
a main computer chassis having a direct access storage device portion configured to support a direct access storage device cage of a first type or a direct access storage device cage of a second type; and
a direct access storage device cage of the first type or the second type having a serial attached small computer system interface backplane,
wherein a direct access storage device cage of a first type supports a first number of standard form factor direct access storage devices and wherein the serial attached small computer system interface backplane comprises the first number of direct access storage device connectors, and
wherein a direct access storage device cage of a second type supports a second number of small form factor direct access storage devices and wherein the serial attached small computer system interface backplane comprises the second number of direct access storage device connectors.

12. The computer system of claim 11, wherein the standard form factor direct access storage devices are 3.5-inch hard disk drives.

13. The computer system of claim 11, wherein the small form factor direct access storage devices are 2.5-inch hard disk drives.

14. The computer system of claim 11, wherein the serial attached small computer system interface backplane comprises at least one port expander.

15. The computer system of claim 11, wherein the main computer chassis has a serial attached small computer system interface controller and wherein the serial attached small computer system interface backplane comprises a main connector, and wherein the main connector connects to the serial attached small computer system interface controller.

16. The computer system of claim 15, wherein the direct access storage device cage is of the second type, and wherein the main connector is connected to the serial attached small computer system interface controller using an interposer.

17. The computer system of claim 11, wherein the serial attached small computer system interface backplane comprises a guiding connector that does not provide any electrical connection.

18. The computer system of claim 11, wherein the main computer chassis has an external serial attached small computer system interface connector and wherein the serial attached small computer system interface backplane comprises a secondary connector, the computer system further comprising:
a serial attached small computer system interface cable,
wherein a first end of a serial attached small computer system interface cable is connected to the secondary connector; and
wherein a second end of the serial attached small computer system interface cable is connected to the external serial attached small computer system interface connector.

19. The computer system of claim 11, wherein the direct access storage device cage is of the first type, the computer system further comprising:
one or more standard form factor direct access storage devices connected to at least a subset of the first number of direct access storage device connectors.

20. The computer system of claim 11, wherein the direct access storage device cage is of the second type, the computer system further comprising:
one or more small form factor direct access storage devices connected to at least a subset of the second number of direct access storage device connectors.
